(19) United States
(12) Patent Application Publication
(10) Pub. No.: US 2013/0266235 A1
(43) Pub. Date: Oct. 10, 2013

(54) IMAGE ENCODING APPARATUS, IMAGE ENCODING METHOD, IMAGE ENCODING PROGRAM, IMAGE DECODING APPARATUS, IMAGE DECODING METHOD, AND IMAGE DECODING PROGRAM

(71) Applicant: CANON KABUSHIKI KAISHA, Tokyo (JP)

(72) Inventor: Masato Shima, Tokyo (JP)

(73) Assignee: CANON KABUSHIKI KAISHA, Tokyo (JP)

(21) Appl. No.: 13/858,362

(22) Filed: Apr. 8, 2013

(30) Foreign Application Priority Data
Apr. 10, 2012 (JP) 2012-089551

(51) Int. Cl. G06T 9/00

(52) U.S. Cl. CPC G06T 9/004
USPC 382/238

(57) ABSTRACT

An image encoding method for encoding an image to generate an image bit stream, comprising encoding an image on a block-by-block basis in a first encoding mode in which a quantization is performed, encoding the image on a block-by-block basis in a second encoding mode in which a quantization is not performed, and filtering a first reproduced image and a second reproduced image generated. The filtering is controlled such that the filtering on the second reproduced image is performed based on filter control information indicating whether the second reproduced image is to be subjected to the filtering.

### BACKGROUND OF THE INVENTION

1. Field of the Invention

The present invention relates to an image encoding apparatus, an image encoding method, an image encoding program, an image decoding apparatus, an image decoding method, and an image decoding program, and more particularly, to a filtering process performed on lossless-encoded blocks.

2. Description of the Related Art

H.264/MPEG-4 AVC (hereinafter referred to simply as H.264) is known as one of methods of encoding a moving image in a compressed form ((ITU-T H.264 (03/2010) Advanced video coding for generic audiovisual services). In H.264, it is allowed to perform lossless encoding by selecting a transformation bypass process in which an orthogonal transformation and a quantization process are bypassed. In recent years, an activity has been started to establish a new international standard associated with a high-efficiency encoding method intended to be a successor to H.264. Joint Collaborative Team on Video Coding (JCT-VC) has been established by ISO/IEC and ITU-T and is working to establish a High Efficiency Video Coding (HEVC) method. To achieve an enhanced encoding efficiency, use of an in-loop filtering process such as an adaptive loop filtering, a sample adaptive offsetting, or the like is under discussion in addition to a conventional deblocking filtering. In HEVC, as in H.264, it is also under consideration to allow lossless encoding by bypassing the orthogonal transformation and the quantization process. One of great features of HEVC is that one picture is allowed to include a mixture of lossless-encoded blocks and usual lossy-encoded blocks. (JCT-VC Contributed Articles, JCTVC-H1003 (Internet URL, http://phenix.int-evry.fr/jct/doc_end_user/documents/8_San %20Jose/wg11/)).

To achieve a high encoding efficiency, it will be effective to use in-loop filtering such as deblocking filtering, adaptive loop filtering or the like. However, in a case where a picture is allowed to include a mixture of lossless-encoded blocks and lossy-encoded blocks as with HEVC, following problems may occur. That is, when in-loop filtering is performed unconditionally at a boundary between a lossless-encoded block and a lossy-encoded block, the filtering process causes pixels in the lossless-encoded block to have errors, which cause the pixels to be no longer lossless. On the other hand, when in-loop filtering is disabled unconditionally at a boundary between a lossless-encoded block and a lossy-encoded block, significant degradation may occur in pixels in the lossy-encoded block. To solve the problems described above, the present invention provides a technique of preventing degradation of pixels in a lossy-encoded block adjacent to a lossless-encoded block without causing the lossless-encoded block to have a loss.

### SUMMARY OF THE INVENTION

An aspect of the invention provides an image encoding method for encoding an image to generate an image bit stream, comprising performing first encoding on the image on a block-by-block basis in a first encoding mode in which quantization is performed, performing second encoding on the image on a block-by-block basis in a second encoding mode in which quantization is not performed, and filtering a first reproduced image generated in the first encoding and a second reproduced image generated in the second encoding, the filtering being controlled such that the filtering on the second reproduced image is performed based on filter control information indicating whether the second reproduced image is to be subjected to the filtering. The aspect of the invention makes it possible to prevent degradation of a pixel in a lossy-encoded block adjacent to a lossless-encoded block without causing the lossless-encoded block to have a loss, which allows a further improvement in encoding efficiency.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image encoding apparatus according to an embodiment.

FIG. 2 is a block diagram illustrating a configuration of an image decoding apparatus according to an embodiment.

FIG. 3A is a diagram illustrating an example of a manner of performing an in-loop filtering process on pixels depending on types of blocks.

FIG. 3B is a diagram illustrating an example of a manner of performing an in-loop filtering process on pixels depending on types of blocks.

FIG. 3C is a diagram illustrating an example of a manner of performing an in-loop filtering process on pixels depending on types of blocks.

FIG. 4 is a flow chart illustrating an encoding process performed by an image encoding apparatus according to an embodiment.

FIG. 5 is a flow chart illustrating an in-loop filtering process performed by an image encoding apparatus according to an embodiment and by an image decoding apparatus according to an embodiment.

FIG. 6A is a diagram illustrating an example of a structure of a bit stream generated by an image encoding apparatus according to an embodiment and decoded by an image decoding apparatus according to an embodiment.

FIG. 6B is a diagram illustrating an example of a structure of a bit stream generated by an image encoding apparatus according to an embodiment and decoded by an image decoding apparatus according to an embodiment.

FIG. 6C is a diagram illustrating an example of a structure of a bit stream generated by an image encoding apparatus according to an embodiment and decoded by an image decoding apparatus according to an embodiment.

FIG. 7 is a flow chart illustrating an image decoding process performed by an image decoding apparatus according to an embodiment.

FIG. 8 is a block diagram illustrating an example of a hardware configuration of a computer usable as an image encoding apparatus or an image decoding apparatus according to an embodiment.

### DESCRIPTION OF THE EMBODIMENTS

The present invention is described in detail below with reference to embodiments in conjunction with accompanying drawings. Note that the embodiments are described by way of example only, and the invention is not limited to details of the embodiments.

### First Embodiment

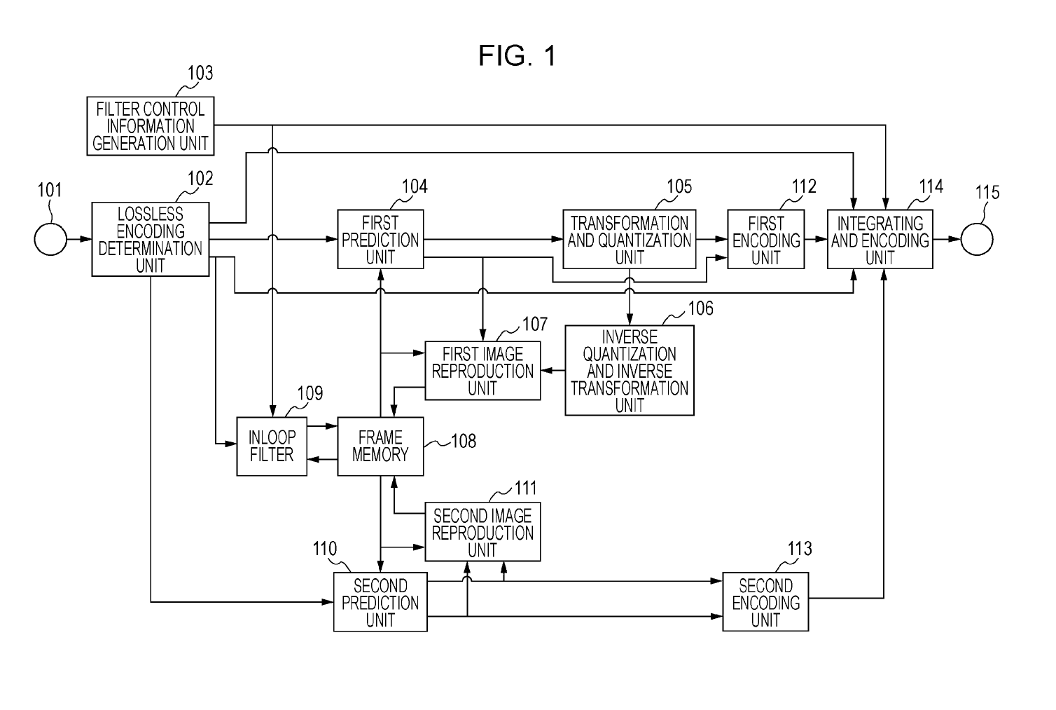

A first embodiment is described below with reference to figures. FIG. 1 is a block diagram illustrating an image encoding apparatus according to the first embodiment. In FIG. 1, a terminal 101 is used to input image data. A lossless encoding determination unit 102 divides the input image data into a plurality of blocks and determines on a block-by-block basis whether lossless encoding or lossy encoding is to be performed. A filter control information generation unit 103 generates filter control information indicating whether an in-loop filtering process is to be performed on a pixel in a lossless-encoded block, and outputs the resultant filter control information. A first prediction unit 104 is configured such that when the lossy encoding is selected, the first prediction unit 104 performs an intraframe prediction (prediction within a frame) or an interframe prediction (prediction between frames) on image data in units of blocks thereby generating predicted image data. Furthermore, the first prediction unit calculates prediction errors from the input image data and the predicted image data and outputs the resultant prediction errors. Note that information necessary in the prediction, such as a prediction mode, is also output together with the prediction errors. Hereinafter, the information necessary in the prediction is referred to as first prediction information.

A transformation and quantization unit 105 performs an orthogonal transformation on the prediction errors on a block-by-block basis thereby obtaining transformation coefficients, and then performs a quantization on the resultant transformation coefficients thereby obtaining quantization coefficients. An inverse quantization and inverse transformation unit 106 performs an inverse quantization on the quantization coefficients output from the transformation and quantization unit 105 thereby reproducing the transformation coefficients and further performs an inverse transformation to reproduce the prediction errors. A frame memory 108 stores the reproduced image data. Based on the first prediction information output from the first prediction unit 104, a first image reproduction unit 107 generates predicted image data while referring to the frame memory 108 as required. The first image reproduction unit 107 then generates reproduced image data from the predicted image data and the input prediction errors, and outputs the resultant reproduced image data.

An in-loop filter unit 109 performs an in-loop filtering process such as deblocking filtering on the reproduced image and outputs the resultant image. A second prediction unit 110 is configured such that when the lossless encoding is selected, the second prediction unit 110 performs an intra-prediction or an inter prediction on the image data in units of blocks thereby generating predicted image data. As with the first prediction unit 104, the second prediction unit 110 calculates prediction errors from the input image data and the predicted image data and outputs the calculated prediction errors together with information necessary in the prediction such as the prediction mode. Hereinafter, this information necessary in the prediction is referred to as second prediction information.

Based on the second prediction information output from the second prediction unit 110, a second image reproduction unit 111 generates predicted image data while referring to the frame memory 108 as required. The second image reproduction unit 111 then generates reproduced image data from the predicted image data and the input prediction errors, and outputs the resultant reproduced image data. Note that the information necessary in the prediction is also output together with the reproduced image data. A first encoding unit 112 encodes the quantization coefficients output from the transformation and quantization unit 105 and also encodes the first prediction information output from the first prediction unit 104 thereby generating first code data, and the first encoding unit 112 outputs the generated first code data. A second encoding unit 113 encodes the second prediction information and the prediction errors output from the second prediction unit 110. The second encoding unit 113 generates second code data thereby, and outputs the generated second code data. An integrating and encoding unit 114 encodes the output from the lossless encoding determination unit 102 thereby generating header code data. Furthermore, the integrating and encoding unit 114 integrates the generated header code data with the code data output from the first encoding unit 112 and the code data output from the second encoding unit 113, and outputs the resultant integrated data in the form of a bit stream. A terminal 115 is used to output the bit stream generated by the integrating and encoding unit 114 to the outside.

The operation performed by the image encoding apparatus to encode an image is described below. In the following description, it is assumed that moving image data is input on a frame-by-frame basis. Alternatively, one frame of still image data may be input.

One frame of image data input via the terminal 101 is applied to the lossless encoding determination unit 102. Before the encoding process is performed, the filter control information generation unit 103 determines whether pixels in a lossless-encoded block are to be subjected to an in-loop filtering process, and information indicating whether pixels are to be subjected to the in-loop filtering process or not is output as filter control information to the in-loop filter unit 109 and the integrating and encoding unit 114. Note that there is no particular restriction on the method of determining the filter control mode. The filter control information may be determined based on a characteristic of an input image or based on an input given by a user. The integrating and encoding unit 114 generates filter control information code by encoding the filter control information. Note that there is no particular restriction on the encoding method, and many encoding methods such as Golomb coding, arithmetic coding, Huffman coding, etc., may be employed.

The lossless encoding determination unit 102 generates lossless encoding information indicating whether a present frame or sequence includes a block to be subjected to lossless encoding. The integrating and encoding unit 114 encodes the lossless encoding information into a lossless encoding information code. Note that there is no particular restriction on the encoding method, and many encoding methods such as Golomb coding, arithmetic coding, Huffman coding, etc., may be employed.

The lossless encoding determination unit 102 divides the input image data into a plurality of blocks and determines on a block-by-block basis whether lossless encoding or lossy encoding is to be performed. There is no particular restriction on the determination method, and the determination may be made based on a characteristic of an input image or based on an input given by a user. Information indicating whether the block of interest is to be subjected to the lossless encoding or not is output as lossless encoding block information to the in-loop filter unit 109 and the integrating and encoding unit 114. Furthermore, the input image data is directly supplied to the first prediction unit 103 and the second prediction unit 109.

The following encoding operation is performed differently depending on whether the lossless encoding or the lossy encoding is selected by the lossless encoding determination unit 102. First, the operation of encoding the image data is described below for a case where the lossy encoding is selected by the lossless encoding determination unit 102.

The lossless encoding determination unit 102 inputs image data of a block to be encoded to the first prediction unit 104. The first prediction unit 104 performs a prediction on a block-by-block basis and generates prediction errors. The generated prediction errors are supplied to the transformation and quantization unit 105. Furthermore, the first prediction unit 104 generates first prediction information and supplies the generated first prediction information to the first encoding unit 112 and the first image reproduction unit 107. The transformation and quantization unit 105 performs an orthogonal transformation and quantization on the input prediction errors thereby generating quantization coefficients. The generated quantization coefficients are input to the first encoding unit 112 and the inverse quantization and inverse transformation unit 106. The inverse quantization and inverse transformation unit 106 reproduces the transformation coefficients by performing an inverse quantization on the input quantization coefficients and further reproduces the prediction errors by performing an inverse orthogonal transformation on the reproduced transformation coefficients. The reproduced prediction errors are supplied to the first image reproduction unit 107.

Based on the first prediction information supplied from the first prediction unit 104, the first image reproduction unit 107 reproduces the predicted image data while referring to the frame memory 108 as required. The first image reproduction unit 107 then reproduces image data from the reproduced predicted image and the reproduced prediction errors supplied from the inverse quantization and inverse transformation unit 106. The reproduced image data is input to the frame memory 108 and stored therein. The in-loop filter unit 109 reads out the reproduced image from the frame memory 108 and performs an in-loop filtering process such as deblocking filtering on the reproduced image based on the lossless encoding block information supplied from the lossless encoding determination unit 102. The image subjected to the filtering process is again input to the frame memory 108 and stored therein.

The first encoding unit 112 generates first code data by performing entropy encoding on the quantization coefficients generated by the transformation and quantization unit 105 and the first prediction information supplied from the first prediction unit 104 on a block-by-block basis. There is no restriction on a specific entropy encoding method, and many encoding methods such as Golomb coding, arithmetic coding, Huffman coding, etc., may be employed. The generated first code data is supplied to the integrating and encoding unit 114.

Next, the operation of encoding the image data is described below for a case where the lossless encoding is selected by the lossless encoding determination unit 102.

The lossless encoding determination unit 102 inputs image data of a block to be encoded to the second prediction unit 110. The second prediction unit 110 performs a prediction on a block-by-block basis thereby generating prediction errors. The resultant generated prediction errors are supplied to the second image reproduction unit 111 and the second encoding unit 113. The second prediction information is also supplied to the second image reproduction unit 111 and the second encoding unit 113. Based on the second prediction information supplied from the second prediction unit 110, the second image reproduction unit 111 reproduces the predicted image data while referring to the frame memory 108 as required. The second image reproduction unit 111 then reproduces image data from the reproduced predicted image and the prediction errors supplied from the second prediction unit 110. The reproduced image data is input to the frame memory 108 and stored therein.

The in-loop filter unit 109 reads out the reproduced image from the frame memory 108. The in-loop filter unit 109 then performs an in-loop filtering process such as deblocking filtering on the reproduced image based on the lossless encoding block information supplied from the lossless encoding determination unit 102 and the filter control information supplied from the filter control information generation unit 103. The image subjected to the filtering process is again input to the frame memory 108.

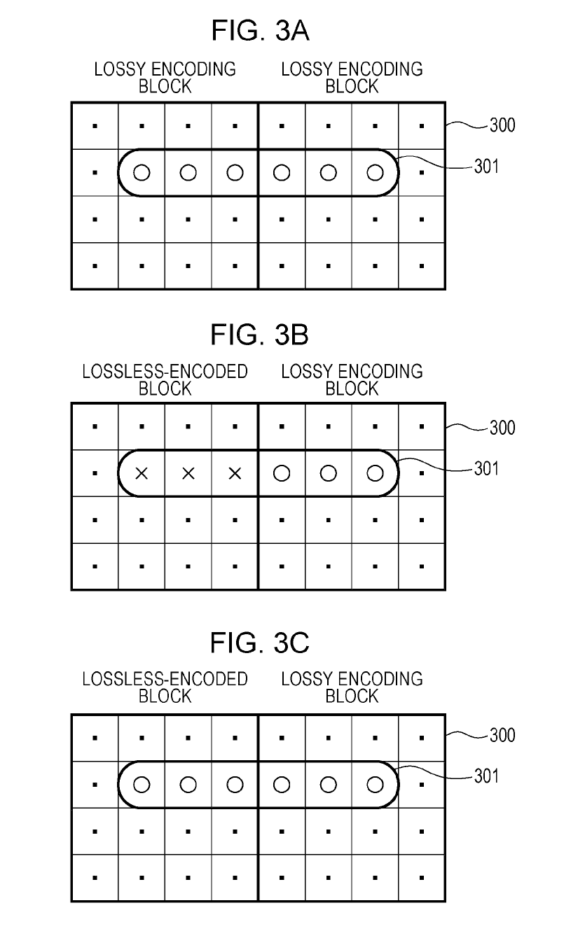

The in-loop filtering process according to the present embodiment is described below with reference to FIGS. 3A to 3C. The filtering process is performed in one of modes described below according to the filter control information. The determination as to whether each block is to be subjected to the lossless encoding or the lossy encoding is made based on the lossless encoding block information. For simplicity of illustration, the block size is assumed to be 4*4 pixels, although the block size is not limited to this value.

FIG. 3A illustrates an example in which a deblocking filtering process is performed across two blocks each having a size of 4*4 pixels. Each of frames 300, located on the right and left sides and represented by thick lines, indicates a block of a size of 4*4 pixels. In this example, three pixels in each block, i.e., a total of six pixels enclosed in a rectangle with rounded corners 301 are subjected to the filtering process. Furthermore, it is assumed that the blocks on the right and left sides are both lossy-encoded blocks. In this example, all six pixels labeled with a symbol of a circle are pixels to be subjected to the filtering process, and thus filtering process is performed on all these six pixels.

In an example illustrated in FIG. 3B, a block on the left side is a lossless-encoded block, and the filter control information specifies that pixels in the lossless-encoded block are not to be subjected to the in-loop filtering process. In this case, three pixels labeled with a symbol of a circle in the block on the right side are to be subjected to the filtering process. However, three pixels labeled with a symbol of x in the block on the left side are not to be subjected to the filtering process. That is, the filtering process is performed only on the three pixels labeled with a symbol of a circle in the block on the right side.

In an example illustrated in FIG. 3C, as in the example illustrated in FIG. 3B, a block on the left side is a lossless-encoded block. However, the filter control information specifies that the in-loop filtering process is to be performed also on pixels in the lossless-encoded block. In this case, all pixels are to be subjected to the filtering process regardless of whether the pixels are lossless-encoded ones or not. That is, all six pixels labeled with a symbol of a circle are subjected to the filtering process.

In the present embodiment, in a case where blocks on the right and left sides are both lossless-encoded blocks, the filtering process is or is not performed according to the filter control information as with the lossless-encoded blocks in the examples illustrated in FIGS. 3B and 3C. However, the filtering process may not be performed regardless of the filter control information.

Although the present embodiment discusses only the deblocking filtering, other in-loop filtering processes such as adaptive filtering, sample adaptive offsetting, or the like may be performed in a similar manner. Although the present embodiment discusses the filtering process performed on blocks adjacent in the horizontal direction, the filtering process is also performed on blocks adjacent in a vertical direction.

Referring again to FIG. 1, the second encoding unit 113 performs entropy encoding on the second prediction information and the prediction errors supplied from the second prediction unit 110 thereby generating second code data. There is no specific restriction on an entropy encoding method, and many encoding methods such as Golomb coding, arithmetic coding, Huffman coding, etc., may be employed. The generated second code data is supplied to the integrating and encoding unit 114.

The integrating and encoding unit 114 generates a bit stream by multiplexing the filter control information code and the lossless encoding information code generated before the encoding process is performed, the first code data generated by the first encoding unit, and the second code data generated by the second encoding unit. The generated bit stream is finally output to the outside via the terminal 115.

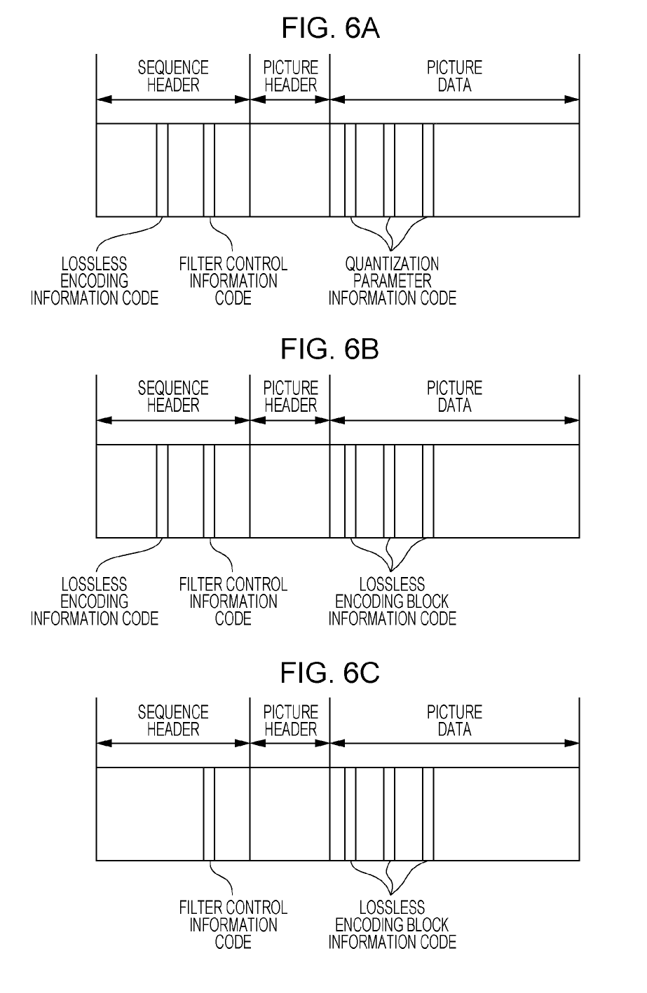

FIG. 6A illustrates an example of a bit stream including the lossless encoding information and the filter control information. The filter control information is included as the filter control information code in one of a sequence header and a picture header. More specifically, the lossless encoding information code is a one-bit flag. When the code is 1, it indicates that there is a possibility that the bit stream includes a lossless-encoded block. On the other hand, when the code is 0, it indicates that there is no possibility that the bit stream includes a lossless-encoded block. The filter control information is information including at least one bit. When the code is 1, it indicates that the in-loop filtering process is to be performed on pixels in lossless-encoded blocks. When the code is 0, it indicates that the in-loop filtering process is not to be performed on pixels in lossless-encoded blocks.

On the other hand, in the present embodiment, it is assumed that the lossless encoding block information is combined with a quantization parameter information code and included in the bit stream. In a case where the lossless encoding information code is 1 and a quantization parameter calculated on a block-by-block basis based on the quantization parameter information code has a particular value, the block of interest is subjected to the lossless encoding, but otherwise the block of interest is subjected to the lossy encoding. For example, in the case of H.264, when the lossless encoding information code is 1 and the quantization parameter is 0, it is specified to perform lossless encoding on the block of interest.

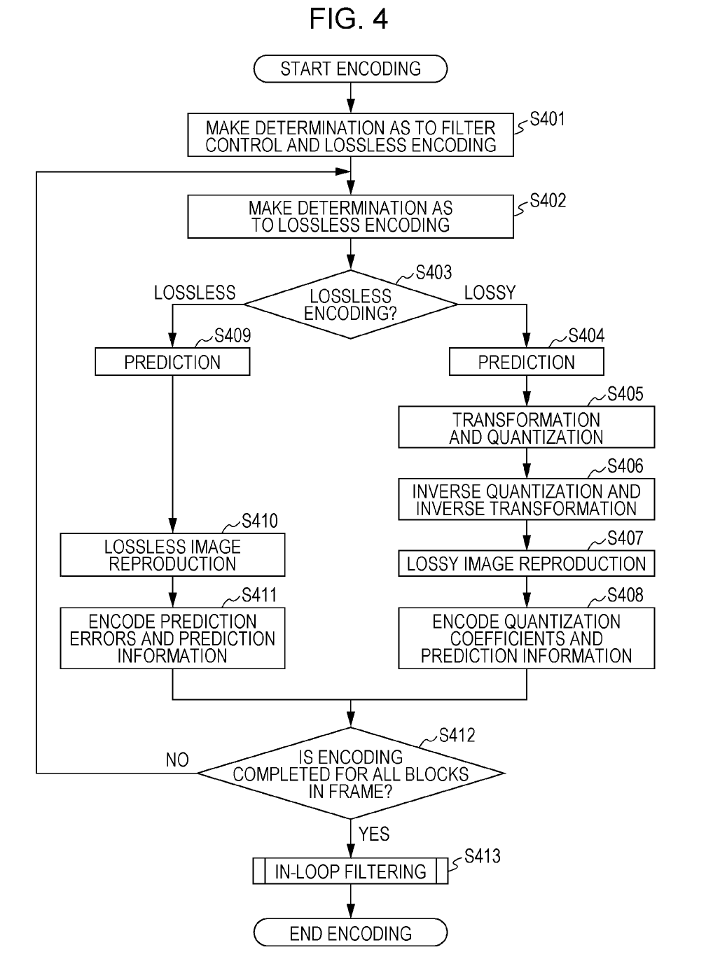

FIG. 4 is a flow chart illustrating an encoding process performed by the image encoding apparatus according to the first embodiment. First, in step S401, the filter control information generation unit 103 determines whether the in-loop filtering process is to be performed on pixels in lossless-encoded blocks and the filter control information generation unit 103 outputs filter control information indicating the result of determination. The lossless encoding determination unit 102 determines whether to perform the lossless encoding, and outputs lossless encoding information indicating the result of determination. These pieces of information are encoded by the integrating and encoding unit 114.

In step S402, the lossless encoding determination unit 102 divides the input image data into a plurality of blocks and determines whether the lossless encoding is to be performed on the blocks on a block-by-block basis. The lossless encoding determination unit 102 outputs lossless encoding block information indicating the result of the determination. In step S403, the encoding apparatus determines whether the lossless encoding is to be performed on a block of interest. In a case where the lossless encoding is to be performed, the process proceeds to step S409. However, in a case where the lossy encoding is to be performed, the process proceeds to step S404.

In step S404, the first prediction unit 104 performs the intra prediction or the inter prediction thereby generating predicted image data and first prediction information. Furthermore, the first prediction unit 104 calculates prediction errors from the input image data and the predicted image data. In step S405, the transformation and quantization unit 105 performs the orthogonal transformation on the prediction errors calculated in step S404 thereby generating transformation coefficients. The transformation and quantization unit 105 further performs the quantization on the generated transformation coefficients thereby generating quantization coefficients.

In step S406, the inverse quantization and inverse transformation unit 106 performs the inverse quantization and inverse transformation on the quantization coefficients generated in step S405 thereby reproducing prediction errors. In step S407, the first image reproduction unit 107 reproduces the predicted image based on the first prediction information generated in step S404. Furthermore, the first image reproduction unit 107 reproduces the image data from the reproduced predicted image and the prediction errors generated in step S406.

In step S408, the first encoding unit 112 encodes the first prediction information generated in step S404 and the quantization coefficients generated in step S405 thereby generating first code data. The first encoding unit 112 generates a bit stream by multiplexing the first code data and other code data.

On the other hand, in step S409, the second prediction unit 110 performs the prediction on a block-by-block basis thereby generating second prediction information and predicted image data. Furthermore, the second prediction unit 110 calculates prediction errors from the input image data and the predicted image data. In step S410, the second image reproduction unit 111 reproduces the predicted image based on the second prediction information generated in step S409. Furthermore, the second image reproduction unit 111 reproduces the image data from the reproduced predicted image and the prediction errors generated in step S409.

In step S411, the second encoding unit 113 encodes the second prediction information and the prediction errors generated in step S409 thereby generating second code data. The second encoding unit 113 generates a bit stream by multiplexing the second code data and other code data. In step S412, the image encoding apparatus determines whether the encoding is completed for all blocks. If the encoding is completed for all blocks, the process proceeds to step S413, but otherwise the process returns to step S402 to encode a next block.

In step S413, the in-loop filter unit 109 performs the in-loop filtering process on the image data reproduced in step S407 or step S410 thereby generating a filtered image. The process is then ended.

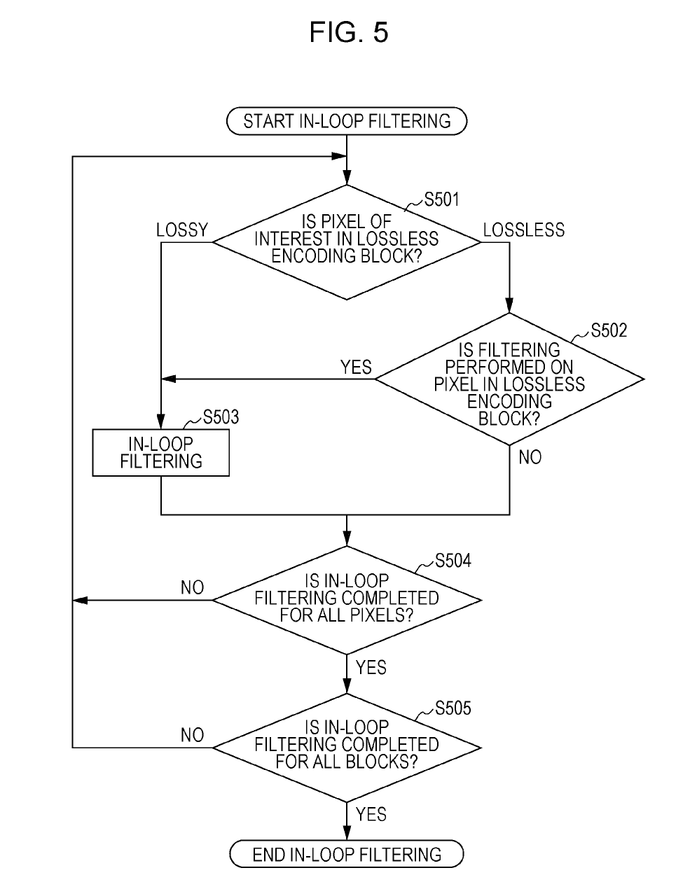

FIG. 5 is a flow chart illustrating the details of the in-loop filtering process in step S413. First, in step S501, it is determined whether a pixel of interest to be subjected to the in-loop filtering is in a lossless-encoded block or not based on the lossless encoding block information generated in step S402. When the pixel of interest is in a lossless-encoded block, the process proceeds to step S502. On the other hand, when the pixel of interest is in a lossy-encoded block, the process proceeds to step S503. In step S502, it is determined whether the pixel in the lossless-encoded block is also to be subjected to the filtering process based on the filter control information generated in step S401. In a case where the filtering is to be performed, the process proceeds to step S503, but otherwise the process proceeds to step S504.

In step S503, the in-loop filtering process is performed on the pixel of interest. In the examples illustrated in FIG. 3A, FIG. 3B, and FIG. 3C, pixels labeled with a circle are subjected to the in-loop filtering process. In step S504, the in-loop filter unit 109 determines whether the in-loop filtering process is completed for all pixels. When the in-loop filtering process is completed for all pixels, the process proceeds to step S505, but otherwise the processing flow returns to step S501 to process a next pixel.

In step S505, the in-loop filter unit 109 determines whether all blocks have been subjected to one of modes of the in-loop filtering process. When all blocks have been subjected to one of modes of the in-loop filtering process, the in-loop filtering process is ended, but otherwise the processing flow returns to step S501 to perform the in-loop filtering process on a next block. For example, in the case of HEVC, the in-loop filtering process includes three modes, i.e., deblocking filtering, sample adaptive offsetting, and adaptive loop filtering, and the mode is selected in this step.

By performing the operation using the apparatus configured in the above-described manner, in particular, in step S413, by controlling the in-loop filtering process on pixels in lossless-encoded blocks, it becomes possible to improve image quality in lossy-encoded blocks while maintaining a lossless characteristic of lossless-encoded blocks. In a case where the in-loop filtering process is performed also on a lossless-encoded block, it is allowed to perform the in-loop filtering process at a boundary between the lossless-encoded block and an adjacent lossy-encoded block, which allows an improvement in image quality of a whole picture.

In the present embodiment, the first prediction unit and first image reproduction unit for the lossless encoding are provided separately from the second prediction unit and second image reproduction unit for the lossy encoding. Alternatively, a single prediction unit and a single image reproduction unit may be provided to perform both the lossless encoding process and the lossy encoding process. In the present embodiment, the first encoding unit and the second encoding unit are provided separately. Alternatively, a single encoding unit may perform both the lossless encoding process and the lossy encoding process.

In the present embodiment, the lossless encoding information is encoded in the form of a combination of a flag in a sequence header and a quantization parameter on a block level. However, the encoding may be performed differently. For example, a flag specifying lossless encoding may be encoded on a block level or a flag specifying lossless encoding on a sequence level may be included in a header.

JCT-VC Contributed Articles, JCTVC-E192 (Internet URL, http://phenix.int-evry.fr/jct/doc_end_user/documents/5_Geneva/wg11/) discloses a technique of controlling the in-loop filtering process performed on pixels belonging to an uncompressed multiplexed mode. The present embodiment provides a technique of applying the in-loop filtering process depending on the purpose also in the lossless encoding mode which is expected to provide a higher compression ratio than the uncompressed multiplexed mode provides. In the technique disclosed in JCT-VC Contributed Articles, JCTVC-E192 (Internet URL, http://phenix.int-evry.fr/jct/doc_end_user/documents/5_Geneva/wg11/), information is encoded to specify whether the in-loop filtering process is to be performed on pixels belonging to the uncompressed multiplexed mode. This information may be incorporated into the filter control information according to the present embodiment.

The filter control information may take a plurality of values, for example, to specify modes of the filtering process individually for lossless-encoded blocks and lossy-encoded blocks. For example, the filter control information may take a value of 0 to specify that the filtering process is to be performed only on lossy-encoded blocks. The filter control information may take a value of 1 to specify that the filtering process is to be performed on both a lossy-encoded block and a lossless-encoded block when the lossy-encoded block is located adjacent to the lossless-encoded block. The filter control information may take a value of 2 to specify that the filtering process is to be performed also on two lossless-encoded blocks adjacent to each other.

The configuration of the bit stream is not limited to that described above with reference to FIG. 6A. For example, the bit stream may be configured as illustrated in FIG. 6B. In the example illustrated in FIG. 6B, a lossless information code is included in a sequence header. When the lossless encoding information code is 1, it indicates that a lossless encoding block information code is included on a block-by-block basis to indicate whether the block is a lossless encoded block or not separately from a quantization parameter information code. This makes it possible to suppress the amount of codes of the bit stream including only lossy-encoded blocks.

FIG. 6C illustrates another example of a configuration of a bit stream. In this example illustrated in FIG. 6C, a lossless encoding information code is not included on a sequence-by-sequence basis. Instead, a lossless encoding block information code is included in each of all blocks to indicate whether the block of interest is a lossless-encoded block or not on a block-by-block basis. This configuration makes it possible to easily distinguish between lossless-encoded blocks and lossy-encoded blocks.

### Second Embodiment

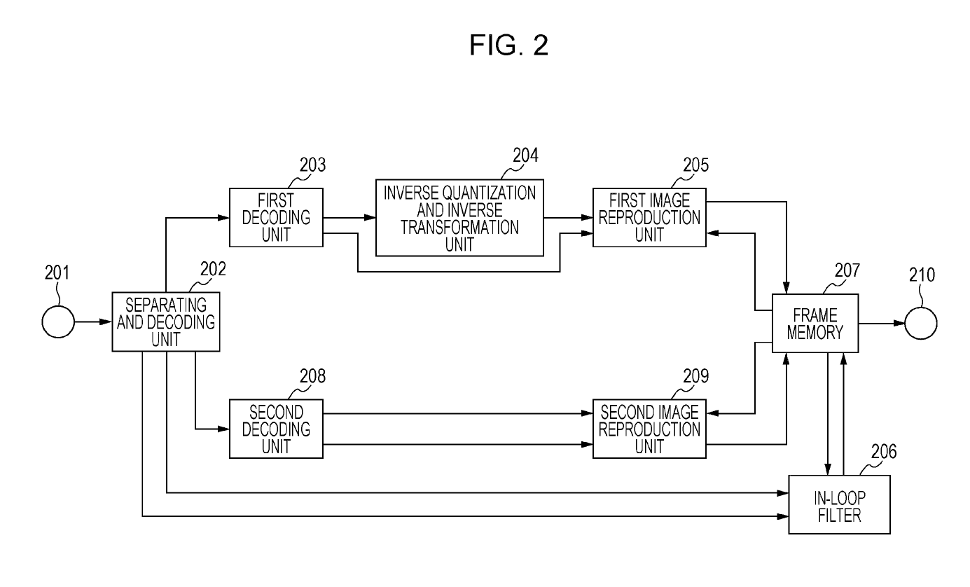

FIG. 2 is a block diagram illustrating a configuration of an image decoding apparatus according to a second embodiment of the invention. In this embodiment, by way of example, the encoded data generated according to the first embodiment is decoded.

A terminal 201 is used to input an encoded bit stream. A separating and decoding unit 202 separates information associated with a decoding process and code data associated with coefficients from the bit stream, and decodes the code data described in a header of the bit stream. In the present embodiment, filter control information and lossless encoding block information are reproduced and output to a following stage. Thus, the operation of the separating and decoding unit 202 is opposite to the operation performed by the integrating and encoding unit 114 illustrated in FIG. 1.

A first decoding unit 203 decodes the first code data output from the separating and decoding unit 202 thereby reproducing quantization coefficients and first prediction information. An inverse quantization and inverse transformation unit 204 operates in a similar manner to the inverse quantization and inverse transformation unit 106 illustrated in FIG. 1. That is, the inverse quantization and inverse transformation unit 204 performs an inverse quantization on the quantization coefficients input on a block-by-block basis thereby obtaining transformation coefficients and further performs an inverse transformation to reproduce prediction errors. A frame memory 207 stores the reproduced picture image data.

A first image reproduction unit 205 operates in a similar manner to the first image reproduction unit 107 illustrated in FIG. 1. That is, based on the given first prediction information, the first image reproduction unit 205 generates predicted image data while referring to the frame memory 207 as required. The first image reproduction unit 205 then generates reproduced image data from the predicted image data and the prediction errors reproduced by the inverse quantization and inverse transformation unit 204, and outputs the resultant reproduced image data. An in-loop filter unit 206 operates in a similar manner to the in-loop filter unit 109 illustrated in FIG. 1. That is, the in-loop filter unit 206 performs an in-loop filtering process such as deblocking filtering on the reproduced image and outputs the resultant image.

A second decoding unit 208 decodes the second code data output from the separating and decoding unit 202 thereby reproducing the prediction errors and the second prediction information. A second image reproduction unit 209 operates in a similar manner to the second image reproduction unit 111 illustrated in FIG. 1. That is, based on the given second prediction information, the second image reproduction unit 209 generates predicted image data while referring to the frame memory 207 as required. The second image reproduction unit 209 then generates reproduced image data from the predicted image data and the input prediction errors, and outputs the resultant reproduced image data. A terminal 210 is used to output the image data to the outside.

The operation performed by the image decoding apparatus to decode an image is described below. In the present embodiment, by way of example, the bit stream generated according to the first embodiment is decoded.

In FIG. 2, a bit stream input to the terminal 201 is applied to the separating and decoding unit 202. The separating and decoding unit 202 separates information associated with the decoding process and code data associated with coefficients from the bit stream, and the separating and decoding unit 202 decodes code data described in a header of the bit stream. More specifically, filter control information and lossless encoding information are reproduced. In the present embodiment, first, a lossless encoding information code is extracted from a sequence header of a bit stream illustrated in FIG. 6A, and the extracted lossless encoding information code is decoded. Based on the decoded lossless encoding information code and a quantization parameter reproduced from a quantization parameter information code included in picture data, it is determined on a block-by-block basis whether a given block is a lossless-encoded block or a lossy-encoded block. More specifically, when the lossless encoding information code is 1 and the quantization parameter has a particular value, the block of interest is determined as being a lossless-encoded block, but otherwise the block of interest is determined as being a lossy-encoded block. Information indicating the result of the determination is given as lossless encoding block information. A filter control information code is extracted from a sequence header and decoded thereby reproducing filter control information. Thereafter, code data of picture data is output on a block-by-block basis to the following stage. Based on the lossless encoding block information, first code data is reproduced from each lossy-encoded block and output to the first decoding unit 203, while second code data is reproduced from each lossless-encoded block and output to the second decoding unit 208. The filter control information and the lossless encoding block information are supplied to the in-loop filter unit 206.

The first decoding unit 203 decodes the first code data thereby reproducing quantization coefficients and first prediction information. The reproduced quantization coefficients are supplied to the inverse quantization and inverse transformation unit 204, while the reproduced first prediction information is supplied to the first image reproduction unit 205. When the given block is a lossy-encoded block, the inverse quantization and inverse transformation unit 204 performs the inverse quantization on the input quantization coefficients thereby generating orthogonal transformation coefficients and further performs the inverse orthogonal transformation on the generated orthogonal transformation coefficients thereby reproducing prediction errors. The reproduced prediction information is input to the first image reproduction unit 205.

Based on the first prediction information supplied from the first decoding unit 203, the first image reproduction unit 205 reproduces a predicted image while referring to the frame memory 207 as required. Image data is then reproduced from the predicted image and the prediction errors supplied from the inverse quantization and inverse transformation unit 204. The reproduced image data is input to the frame memory 207 and stored therein. The stored image data is referred to, in the prediction operation. On the other hand, the second decoding unit 208 decodes the second code data thereby reproducing prediction errors and second prediction information. The reproduced predicted image and second prediction information are supplied to the second image reproduction unit 209.

Based on the second prediction information supplied from the second decoding unit 208, the second image reproduction unit 209 reproduces a predicted image while referring to the frame memory 207 as required. Image data is then reproduced from the predicted image and the prediction errors supplied from the second decoding unit 208. The reproduced image data is input to the frame memory 207 and stored therein. The in-loop filter unit 206 operates in a similar manner to the in-loop filter unit 109 illustrated in FIG. 1. That is, the in-loop filter unit 206 reads out the reproduced image from the frame memory 207 and performs an in-loop filtering process such as deblocking filtering on the reproduced image based on the filter control information and the lossless encoding information supplied from the separating and decoding unit 202. The image subjected to the filtering process is again input to the frame memory 207. The in-loop filtering process according to the present embodiment is similar to the in-loop filtering process according to the first embodiment, and thus a further detailed description thereof is omitted.

The image subjected to the filtering process performed by the in-loop filter unit 206 is again stored in the frame memory 207, and is finally output to the outside via the terminal 208.

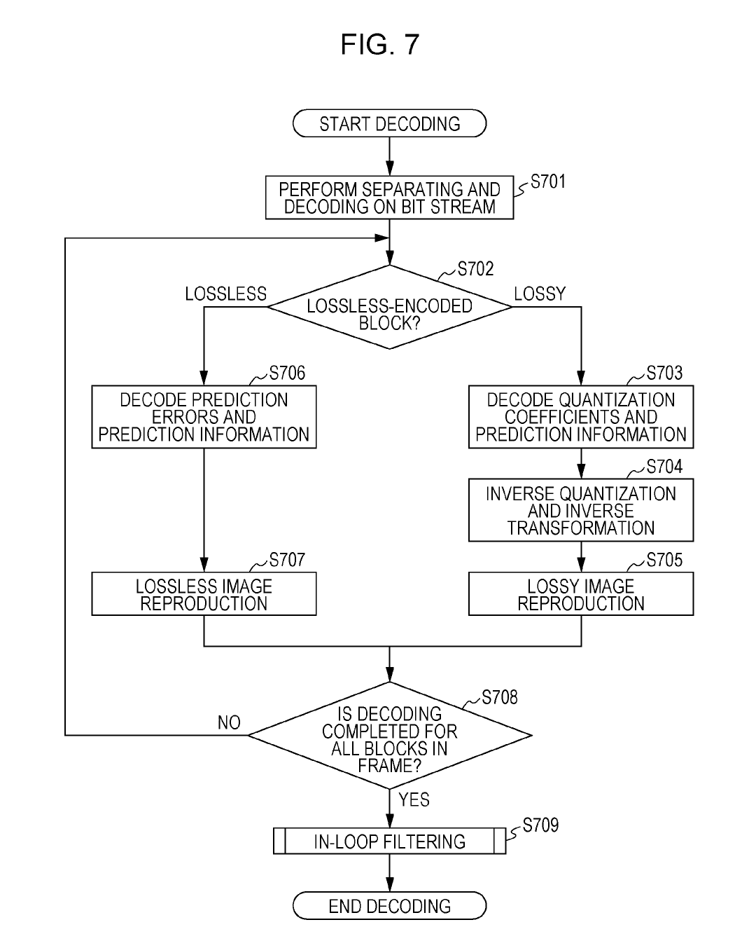

FIG. 7 is a flow chart illustrating an image decoding process performed by an image decoding apparatus according to the second embodiment.

First, in step S701, the separating and decoding unit 202 separates information associated with the decoding process and code data associated with coefficients from a bit stream, and decodes second code data in a header thereby reproducing filter control information and lossless encoding block information. In step S702, the decoding apparatus determines whether a block of interest to be decoded is a lossless-encoded block or not based on the lossless encoding block information reproduced in step S701. When the block of interest is a lossless-encoded block, the process proceeds to step S706. On the other hand, when the block of interest is a lossy-encoded block, the process proceeds to step S703.

In step S703, the first decoding unit 203 decodes the first code data separated in step S701 thereby reproducing quantization coefficients and first prediction information. In step S704, the inverse quantization and inverse transformation unit 204 performs an inverse quantization on the quantization coefficients on a block-by-block basis thereby obtaining transformation coefficients and further performs an inverse transformation to reproduce prediction errors. In step S705, the first image reproduction unit 205 reproduces a predicted image based on the first prediction information generated in step S703 and further reproduces image data from the reproduced predicted image and the prediction errors generated in step S704.

On the other hand, in step S706, the second decoding unit 208 decodes the second code data separated in step S702 thereby reproducing prediction errors and second prediction information. In step S707, the second image reproduction unit 209 reproduces a predicted image based on the prediction information generated in step S706 and further reproduces image data from the reproduced predicted image and the prediction errors generated in step S706.

In step S708, the image decoding apparatus determines whether the decoding is completed for all blocks. If the decoding is completed for all blocks, the process proceeds to step S709, but otherwise the process returns to step S702 to decode a next block. In step S709, the in-loop filter unit 206 performs the in-loop filtering process on the image data reproduced in step S705 or step S707 thereby generating a filtered image. The process is then ended.

The details of the in-loop filtering process is similar to those according to the first embodiment described above with reference to FIG. 5, and thus a further description thereof is omitted.

By performing the operation using the apparatus configured in the above-described manner, it becomes possible to decode a bit stream which is generated according to the first embodiment in such a manner that the in-loop filtering process on lossless-encoded blocks is controllable.

In the present embodiment, the first image reproduction unit and the second image reproduction unit are provided separately for independently reproducing lossless-encoded blocks and lossy-encoded blocks. Alternatively, a single image reproduction unit may decode both lossless-encoded blocks and lossy-encoded blocks. In the present embodiment, the first decoding unit and the second decoding unit are provided separately. Alternatively, a single decoding unit may perform the decoding process on both lossless-encoded blocks and lossy-encoded blocks.

In the present embodiment, by way of example, the bit stream illustrated in FIG. 6A is decoded. However, the configuration of the bit stream to be subjected to the decoding is not limited to that illustrated in FIG. 6A. For example, the decoding may be performed on the bit stream configured as illustrated in FIG. 6B. In the example illustrated in FIG. 6B, a lossless information code is included in a sequence header. When the lossless encoding information code is 1, it indicates that a lossless encoding block information code is included on a block-by-block basis to indicate whether the block is a lossless encoded block or not separately from a quantization parameter information code. This makes it possible to decode the bit stream generated so as to include only lossy-encoded blocks with a suppressed amount of code.

The decoding may be performed on a bit stream configured as illustrated in FIG. 6C. In the example illustrated in FIG. 6C, a lossless encoding information code is not included on a sequence-by-sequence basis. Instead, a lossless encoding block information code is included in each of all blocks to indicate whether the block of interest is a lossless-encoded block or not on a block-by-block basis. This configuration makes it possible to encode a bit stream in which lossless-encoded blocks and lossy-encoded blocks are easily distinguished.

### Third Embodiment

In the previous embodiments, it is assumed that processing units illustrated in FIG. 1 and FIG. 2 are configured by hardware. Alternatively, processes performed by the processing units may be performed by a computer by executing a computer program.

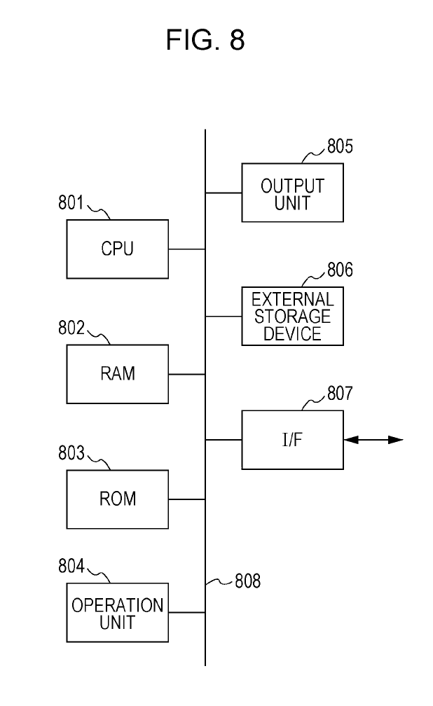

FIG. 8 is a block diagram illustrating an example of a hardware configuration of a computer usable as an image encoding apparatus or an image decoding apparatus according to one of embodiments described above.

A CPU 801 controls the whole computer using a computer program and associated data stored in a RAM 802 or a ROM 803. In addition, the CPU 801 performs various processes, which are assumed, in the previous embodiments, to be performed by the image encoding apparatus or the image decoding apparatus. In other words, the CPU 801 functions as the processing units illustrated in FIG. 1 and FIG. 2.

The RAM 802 has a storage area usable to temporarily store a computer program or data loaded from an external storage device 806 or data acquired from the outside via an interface (I/F) 807. The RAM 802 also has a work area used by the CPU 801 in performing various processes. That is, the RAM 802 may provide various storage areas which may be used as a frame memory or for other purposes.

The ROM 803 stores setting data associated with the computer, a boot program, and the like. An operation unit 804 includes a keyboard, a mouse, or the like for use by a user of the computer to input various commands or data to the CPU 801. A display unit 805 displays a result of a process performed by the CPU 801. The display unit 805 may be, for example, a liquid crystal display.

The external storage device 806 is a mass-storage device typified by a hard disk drive. The external storage device 806 stores an operating system (OS) and other computer programs used by the CPU 801 to realize the functions of various units illustrated in FIG. 1 and FIG. 2. Furthermore, external storage device 806 may store image data to be processed.

The computer programs and data stored in the external storage device 806 may be loaded, under the control of the CPU 801, into the RAM 802 as required and executed or processed by the CPU 801. The I/F 807 may be connected to a network such as a LAN, the Internet, or the like and may be connected to apparatuses such as a projector, a display apparatus, or the like such that the computer is allowed to receive or transmit various kinds of information via the I/F 807. The various units described above are connected to each other via a bus 808.

The operation in the computer configured in the above-described manner, in particular, the operation associated with the processes described above with reference to the flow charts is controlled mainly by the CPU 801.

### Other Embodiments

Aspects of the present invention may also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-089551 filed Apr. 10, 2012, which is hereby incorporated by reference herein in its entirety.

What is claimed is:

1. An image encoding method for encoding an image to generate an image bit stream, comprising:
performing first encoding on the image on a block-by-block basis in a first encoding mode in which quantization is performed;
performing second encoding on the image on a block-by-block basis in a second encoding mode in which quantization is not performed; and
filtering a first reproduced image generated in the first encoding and a second reproduced image generated in the second encoding,
the filtering being controlled such that the filtering on the second reproduced image is performed based on filter control information indicating whether the second reproduced image is to be subjected to the filtering.

2. The image encoding method according to claim 1, further comprising performing integrating and encoding including encoding information necessary in encoding and generating a bit stream, wherein the integrating and encoding includes encoding the filter control information.

3. The image encoding method according to claim 1, wherein the first encoding includes
performing a first prediction on each of blocks divided from the image and generating a prediction error,
performing a transformation and a quantization including performing an orthogonal transformation on the prediction error to generate a transformation coefficient and further performing a quantization on the transformation coefficient to generate a quantization coefficient,
performing an inverse quantization and an inverse transformation including performing the inverse quantization on the quantization coefficient to reproduce the transformation coefficient and further performing an inverse orthogonal transformation on the reproduced transformation coefficient to reproduce a first prediction error,
performing a first reconstruction including generating a first reproduced image from the reproduced first prediction error and an already encoded pixel, and
performing a first quantization coefficient encoding including encoding the quantization coefficient.

4. The image encoding method according to claim 1, wherein the second encoding includes
performing a second prediction on each of blocks divided from the image and generating a second prediction error,
performing a second reconstruction including generating a second reproduced image from the reproduced second prediction error and an already encoded pixel, and
performing second prediction error encoding including encoding the second prediction error.

5. The image encoding method according to claim 1, wherein the filter control information further indicates whether filtering is to be performed on an image reproduced from image data encoded in an uncompressed multiplexed mode.

6. An image decoding method for decoding an image bit stream to reproduce an image, comprising:
performing first decoding on a block encoded in a first encoding mode in which an inverse quantization is performed;
performing second decoding on a block encoded in a second encoding mode in which the inverse quantization is not performed; and
filtering a first reproduced image generated in the first decoding and a second reproduced image generated in the second decoding,
the filtering being controlled such that the filtering on the second reproduced image is performed based on filter control information indicating whether the second reproduced image is to be subjected to the filtering.

7. An image encoding apparatus configured to encode an image and generate an image bit stream, comprising:
a first encoding unit configured to encode the image on a block-by-block basis in a first encoding mode in which quantization is performed;
a second encoding unit configured to encode the image on a block-by-block basis in a second encoding mode in which quantization is not performed; and
a filter unit configured to filter a first reproduced image generated by the first encoding unit and a second reproduced image generated by the second encoding unit,
the filter unit being adapted such that the filter unit performs filtering on the second reproduced image based on filter control information indicating whether the second reproduced image is to be subjected to the filtering.

8. The image encoding apparatus according to claim 7, further comprising an integrating and encoding unit configured to encode information necessary in encoding and generate a bit stream,
wherein the integrating and encoding unit encodes the filter control information.

9. The image encoding apparatus according to claim 7, wherein the first encoding unit includes
a first prediction unit configured to perform a prediction on each of blocks divided from the image and generate a prediction error,
a transformation and quantization unit configured to perform an orthogonal transformation on the prediction error to generate a transformation coefficient and further perform a quantization on the transformation coefficient to generate a quantization coefficient,
an inverse quantization and inverse transformation unit configured to perform an inverse quantization on the quantization coefficient to reproduce the transformation coefficient and further perform an inverse orthogonal transformation on the reproduced transformation coefficient to reproduce a first prediction error,
a first reconstruction unit configured to generate a first reproduced image from the reproduced first prediction error and an already encoded pixel, and
a first quantization coefficient encoding unit configured to encode the quantization coefficient.

10. The image encoding apparatus according to claim 7, wherein the second encoding unit includes
a second prediction unit configured to perform a prediction on each of blocks divided from the image and generate a second prediction error,
a second reconstruction unit configured to generate a second reproduced image from the reproduced second prediction error and an already encoded pixel, and
a second prediction error encoding unit configured to encode the second prediction error.

11. The image encoding apparatus according to claim 7, wherein the filter control information further indicates whether filtering is to be performed on an image reproduced from image data encoded in an uncompressed multiplexed mode.

12. An image decoding apparatus configured to decode an image bit stream and reproduce an image, comprising:
a first decoding unit configured to decode a block encoded in a first encoding mode in which an inverse quantization is performed;
a second decoding unit configured to decode a block encoded in a second encoding mode in which an inverse quantization is not performed; and
a filter unit configured to filter a first reproduced image generated by the first decoding unit and a second reproduced image generated by the second decoding unit;
the filter unit being adapted such that the filter unit performs filtering on the second reproduced image based on filter control information indicating whether the second reproduced image is to be subjected to the filtering.

13. A program configured to be read out and executed by a computer to allows the computer to function as the image encoding apparatus according to claim 7.

14. A program configured to be read out and executed by a computer to allows the computer to function as the image decoding apparatus according to claim 12.
